(19) United States
(12) Patent Application Publication
(10) Pub. No.: US 2012/0230172 A1
(43) Pub. Date: Sep. 13, 2012

(54) OPTICAL INFORMATION MEDIUM, OPTICAL INFORMATION RECORDING/REPRODUCING APPARATUS, AND OPTICAL INFORMATION RECORDING/REPRODUCING METHOD

(76) Inventors: Takakiyo YASUKAWA, Fujisawa (JP); Taku Hoshizawa, Hayama (JP); Kunikazu Ohnishi, Yokosuka (JP); Yutaka Nagai, Yokohama (JP)

(21) Appl. No.: 13/412,649

(22) Filed: Mar. 6, 2012

(30) Foreign Application Priority Data
Mar. 11, 2011 (JP) 2011-053707

(51) Int. Cl. G11B 7/004

(52) U.S. Cl. 369/59.11; G9B/7.009

(57) ABSTRACT

In the related art, writing of BCA data has been performed by a BCA cutter or the like after a user data area was formed. However, according to such a method, individual steps cannot help being provided for a disc manufacturing step in order to form the BCA. A burden on the disc manufacturer is large from a viewpoint of the number of disc producing steps and, further, manufacturing costs. By using a bit forming method similar to a user data area, the BCA manufacturing steps can be reduced. Specifically speaking, by devising a pit depth, a pit width, and a pit pattern, a modulation degree of a BCA portion can be further increased. A detecting method similar to that for the BCA in the related art can be applied.

### INCORPORATION BY REFERENCE

The present application claims priority from Japanese application JP2011-053707 filed on Mar. 11, 2011, the content of which is hereby incorporated by reference into this application.

### BACKGROUND OF THE INVENTION

1. Field of the Invention

The invention relates to an optical information medium, an optical information recording/reproducing apparatus, and an optical information recording/reproducing method.

2. Description of the Relates Arts

In an optical disc, for example, Blu-ray Disc (BD), or the like in the related art, a Burst Cutting Area (BCA) is provided on an inner rim of the optical disc in order to manage data stored in a user data area and to protect a copyright of the data. Techniques regarding the BCA have been disclosed in, for example, the Official Gazettes of JP-A-2000-149423 and JPA-2001-043533 and the like.

In the related art, writing of the BCA data has been performed by a BCA cutter or the like after a user data area was formed. However, according to such a method, individual steps cannot help being provided for a disc manufacturing step in order to form the BCA. A burden on the disc manufacturer is large from a viewpoint of the number of disc producing steps and, further, manufacturing costs.

The above problem is solved by the inventions disclosed in claims.

According to the invention, the BCA creation can be realized by an easy method and a detecting method similar to that of the BCA in the related art can be applied.

Other objects, features and advantages of the invention will become apparent from the following description of the embodiments of the invention taken in conjunction with the accompanying drawings.

### BRIEF DESCRIPTION OF THE DRAWINGS

FIGS. 1A to 1C are diagrams showing a BCA structure in the related art and its signal waveform;

FIGS. 2A to 2C are diagrams showing a BCA structure which is used in the invention and its signal waveform;

FIGS. 3A and 3B are diagrams each showing a simulation result of a continuous pattern having a 2T length;

FIGS. 4A and 4B are diagrams each showing a simulation result of a continuous pattern having an 8T length;

FIG. 5 is a diagram showing a pattern of a BCA having a pit structure;

FIG. 6 is a diagram showing a pattern of a BCA having a pit structure;

FIG. 7 is a diagram showing a pattern of a BCA having a pit structure;

FIG. 8 is a diagram illustrating a structure of a single layer ROM disc which is used in the invention;

FIG. 9 is a diagram illustrating a structure of a dual layer ROM disc which is used in the invention;

FIGS. 10A and 10B are diagrams each illustrating a structure of a recording layer of a ROM disc which is used in the invention;

FIG. 11 is a diagram showing a structure of a data frame of a disc which is used in the invention;

FIG. 12 is a diagram showing a structure of a scrambled data frame of the disc which is used in the invention;

FIG. 13 is a constructional diagram showing a data block of 216 rows and 304 columns of the disc which is used in the invention;

FIG. 14 is a diagram showing a structure of an LDC block of the disc which is used in the invention;

FIG. 15A is a constructional diagram showing a first interleave to the LDC block;

FIG. 15B is a constructional diagram showing a second interleave to the LDC block;

FIG. 16 is a diagram showing a structure of address information of the disc which is used in the invention;

FIG. 17 is a diagram showing a structure of an access block of the disc which is used in the invention;

FIG. 18 is a diagram showing a structure of a BIS block of the disc which is used in the invention;

FIG. 19 is a diagram showing a structure of a BIS cluster of the disc which is used in the invention;

FIG. 20 is a diagram showing a structure of an ECC cluster of the disc which is used in the invention;

FIG. 21 is a diagram showing a structure of a recording frame of the disc which is used in the invention;

FIG. 22 is a diagram showing a conversion of a 1-7 modulation which is used in the disc which is used in the invention;

FIG. 23 is a table showing a pattern of a sync signal of a sync frame;

FIG. 24 is a diagram illustrating a structure of a position of a BCA of the disc which is used in the invention;

FIG. 25 is a conversion table showing a modulation rule of the BCA of the disc which is used in the invention;

FIG. 26 is a diagram showing a recording shape of the BCA of the disc which is used in the invention;

FIG. 27 is a diagram showing a data structure of the BCA of the disc which is used in the invention;

FIG. 28 is a table showing a pattern of a sync signal of the BCA;

FIG. 29 is a constructional diagram of an ECC block of a BCA code;

FIG. 30 is a constructional diagram of a data block of the BCA; and

FIG. 31 is a block diagram of an optical disc recording/reproducing apparatus which is used in the invention.

### DESCRIPTION OF THE INVENTION

### [Optical Information Medium]

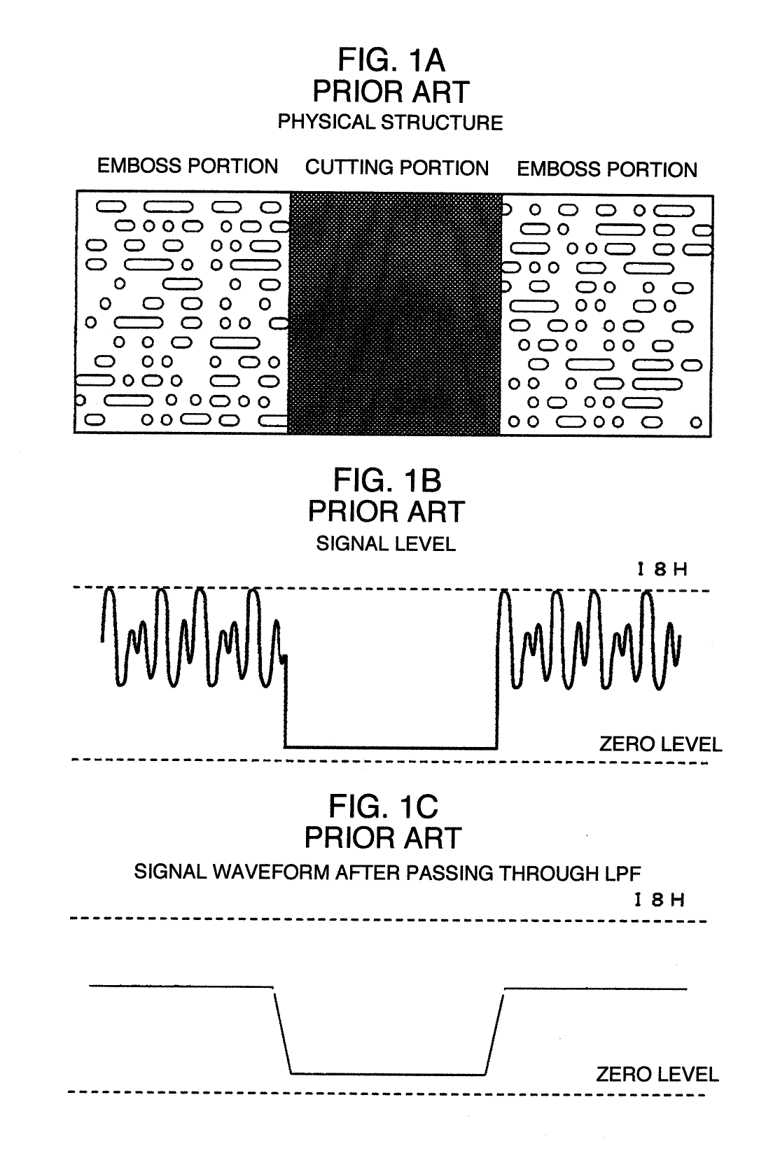

First, an optical information medium which is used in the invention will be described. For simplicity of explanation, in the invention, a system of a BD is used as a prerequisite. FIGS. 1A to 1C are diagrams showing physical characteristics of a BCA structure in the related art and its signal waveform. FIG. 1A shows a physical structure and random data has been formed in an emboss portion serving as a base portion by a modulating method according to a data area. A cutting portion is formed there by using a BCA cutter or the like in a post step. By reducing a reflection level as mentioned above, “1” of a data pattern is constructed and can be discriminated by a difference of reflectance between “1” and “0” of another emboss portion. FIG. 1B shows the waveform which was actually reproduced. The emboss portion has been modulated by the data pattern and a high frequency component is detected. In the cutting portion, the data pattern is completely burned, a reflection light amount decreases largely, and a reproduction signal intensity can be decreased to a level which is almost equal to the zero level. FIG. 1C shows the signal waveform after the signal passed through an LPF for reproduction. The data pattern is a signal of the high frequency component according to the user data area and is detected as a signal center level. Thus, a signal level of the emboss portion decreases to a level lower than 18H (top level of the original waveform) a cutting portion is detected at a level near the zero level.

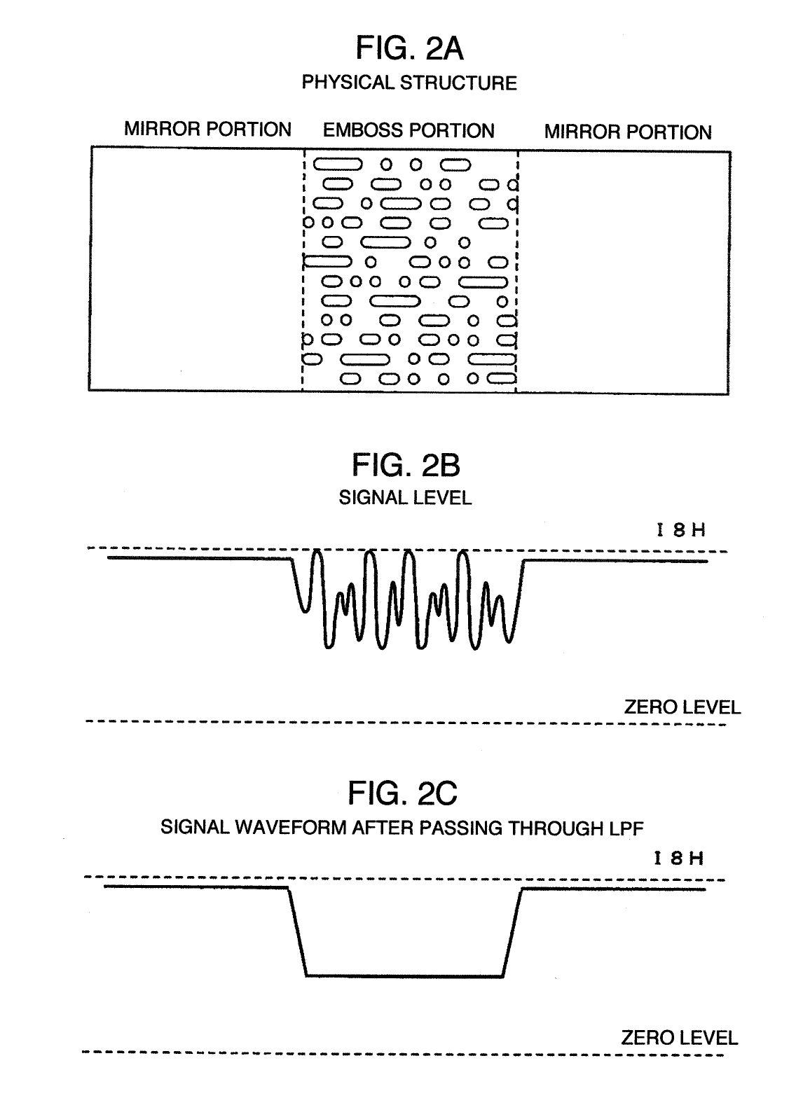

Subsequently, FIGS. 2A to 2C are diagrams showing physical characteristics of a BCA structure of the optical information medium which is used in the invention and its signal waveform. Unlike the BCA in the related art, according to the physical structure of FIG. 2A, a portion constructing a data pattern “0” is a mirror portion, that is, it does not have a light diffraction structure such as a pit or the like but is a structure in which a reflection light amount is largest. An emboss portion constructing a data pattern “1” is a physical structure similar to that of the emboss portion of the BCA in the related art.

Although a difference will be clearly understood by a reproduction waveform in FIG. 2B, the emboss portion constructing the data pattern “1” has reflectance similar to that of the emboss portion of the data pattern “0” of the BCA in the related art and has a waveform different from that of a signal level of the BCA in the related art. Similarly, also in the mirror portion of the data pattern “0”, a signal level is largely shifted to 18H from a center level of a high frequency signal of the data pattern.

Therefore, it is an object of the invention that pit molding conditions which are applied to the BCA are specified and can be detected in a manner similar to the BCA in the related art. A specific method will be described hereinbelow. First, by designing a pit depth to almost ¼ of a laser wavelength, a change in reflection light amount can be most easily detected. According to such a design, although it is difficult to detect a push-pull signal, since there is no need to apply a tracking servo upon reproduction of the BCA, it can be realized.

Subsequently, an evaluation result about a pit shape is shown. Particularly, such conditions that a largest change in reflection light amount, that is, a largest signal modulation degree can be assured are examined. The conditions are compared and examined with respect to a pit length and a pit width.

First, the pit lengths are compared with respect to a continuous pattern of a 2T length and a continuous pattern of an 8T length from a viewpoint of the data modulation. 1T indicates a channel clock.

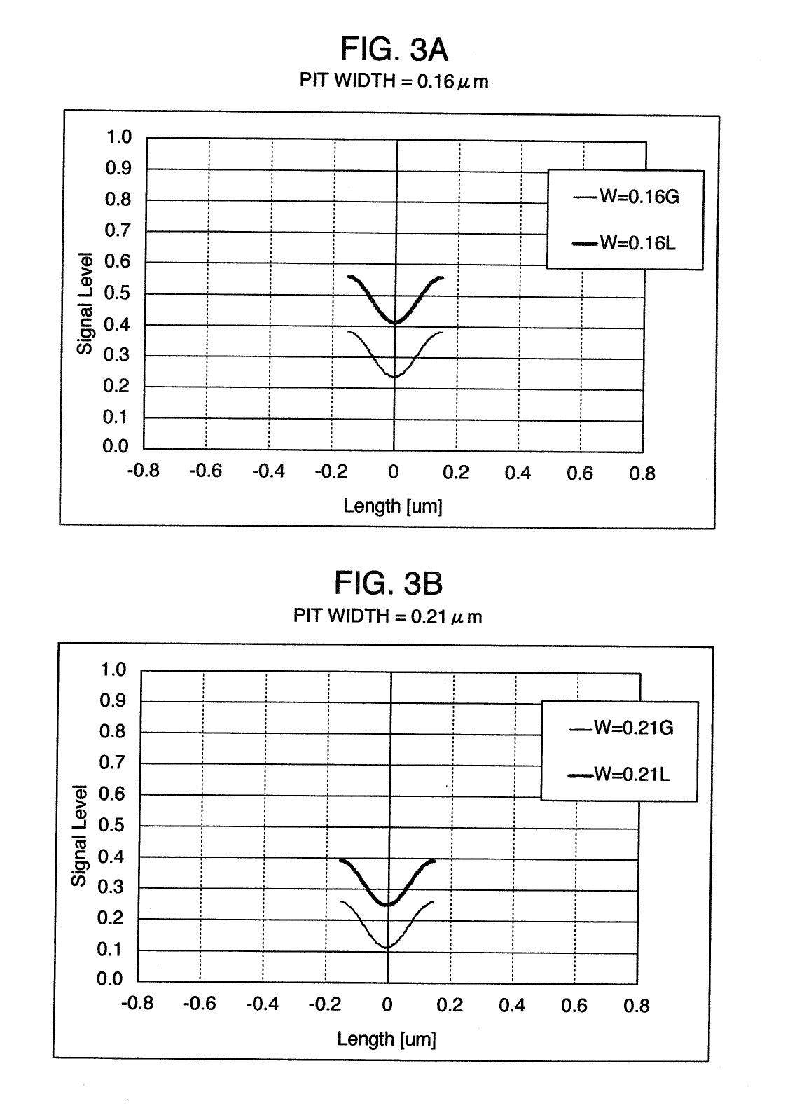

FIGS. 3A and 3B show simulation results of the continuous pattern of the 2T length. FIG. 3A shows a reflection light amount in the case where the pit width is set to 0.16 μm which is equal to the half of a track pitch. G/L indicates a result of a groove, that is, an on-track state and a result of a land, that is, an off-track state, respectively. FIG. 3B shows a result in the case where the pit width is set to 0.21 μm which is equal to almost the half of a spot size at which the reflection light amount is minimum. The signal level “1” is shown as a relative light amount ratio while a mirror level is set to a reference. It will be understood from those results that in the case of the continuous pattern of the 2T length, when the pit width is set to 0.21 μm, an average reflection light amount can be further reduced.

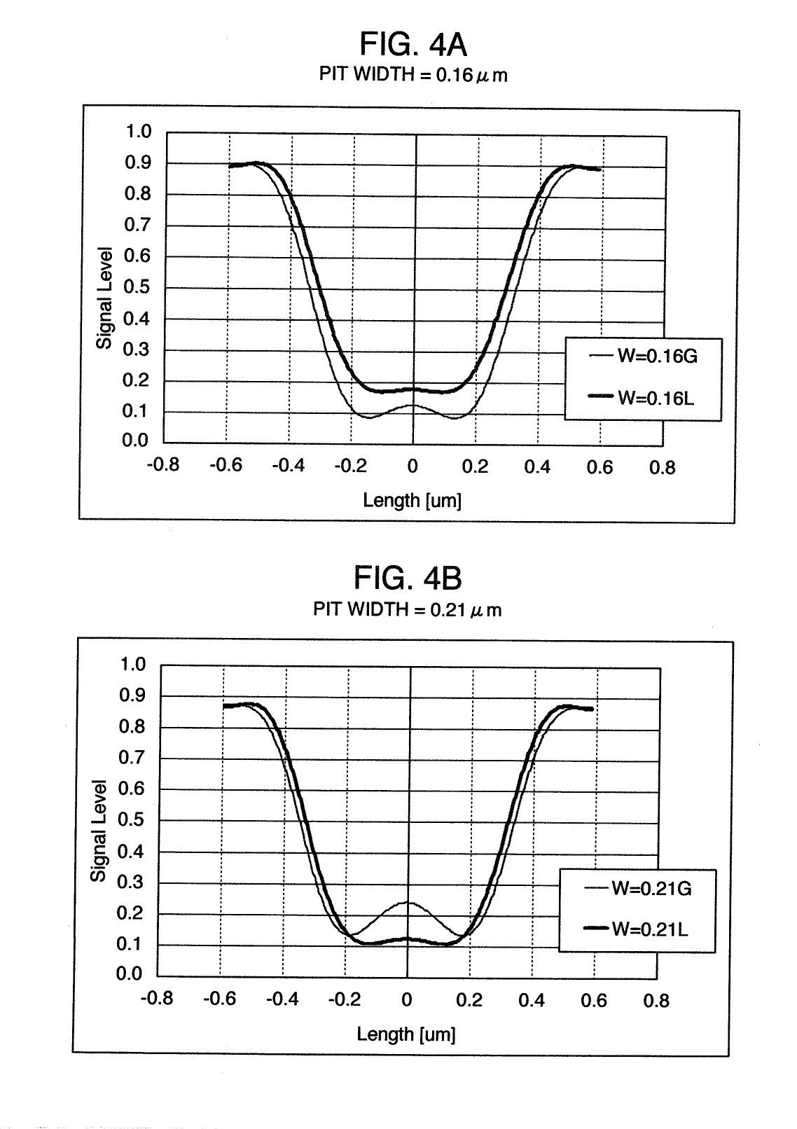

FIGS. 4A and 4B show simulation results of the continuous pattern of the 8T length. Each of FIGS. 4A and 4B shows a result in the case where the pit width is changed in a manner similar to FIGS. 3A and 3B. In the case of the continuous pattern of the 8T length, it will be understood that the signal level in the pit center portion (Length=0 in the diagrams) is equal to 0.25 or less irrespective of the on-track state and the off-track state on the basis of the reference of the mirror portion. A signal level in a land portion (non-pit portion) is equal to about 0.9 corresponding to the mirror portion. From those results, when the pit pattern is used to form the BCA, there is a large change in signal intensity in the pit portion and the land portion. After the signal passed through an LPF for BCA reproduction, all of the signal levels are averaged and are converged to a value near 0.5 as close as possible.

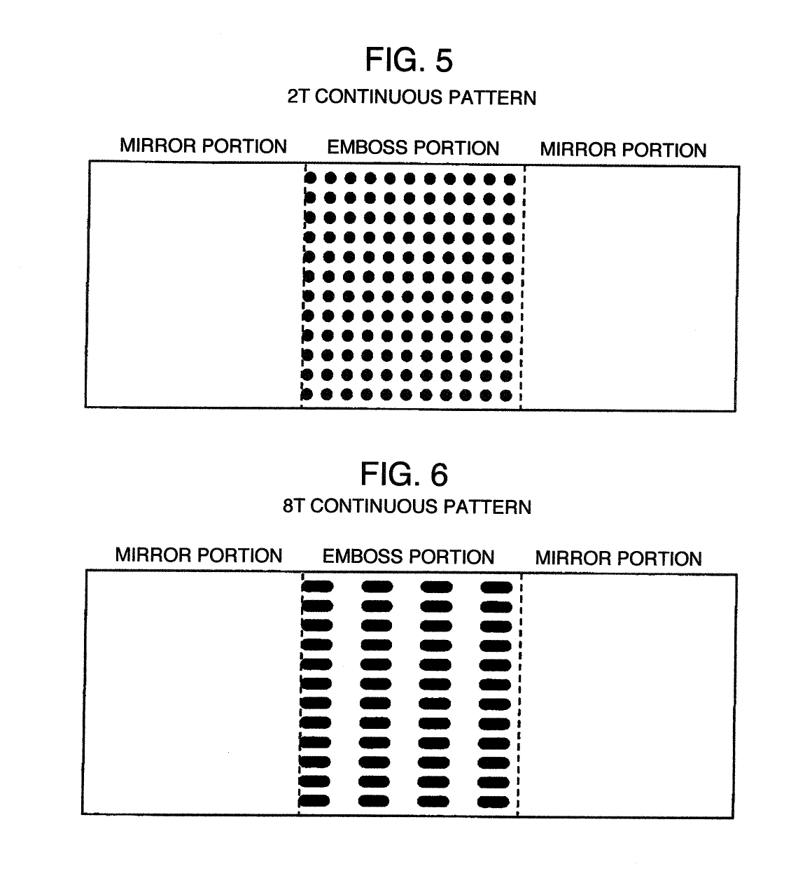

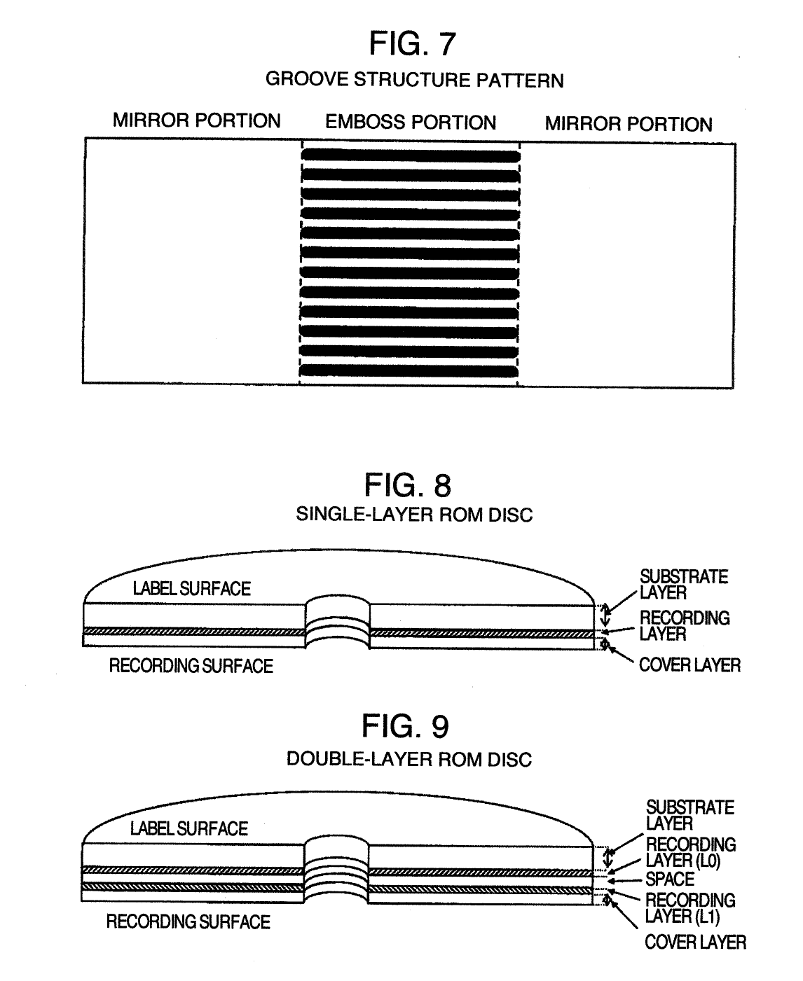

Each of FIGS. 5 to 7 shows an example of the BCA of the pit structure. FIG. 5 is a 2T continuous pattern. FIG. 6 is an 8T continuous pattern. FIG. 7 is a groove structure pattern in which the 8T continuous pattern is expanded. From the conditions of FIGS. 3A to 4B, it is considered that a pit pattern by which the higher modulation degree of the BCA can be assured is obtained in the case where a center portion of a long pit pattern exists continuously. That is, it will be understood that for the BCA of a pit forming type in which the signal level similar to that of the BCA in the related art is assured and no post steps are added, the BCA signal modulation degree can be assured by using a long pit pattern (groove structure) as shown in FIG. 7 instead of such a pattern having a land portion as shown in FIG. 5 or 6. That is, the signal level of a portion of Length=0 in FIGS. 4A and 4B is detected. Thus, although there is a pit width dependency, a value of about 0.25 or less can be realized as a signal level. In the case of a single layer disc of a BD-ROM, it is specified that the maximum reflectance is equal to 70% and the minimum modulation degree (signal amplitude to the reflection light amount) is equal to 40%. Therefore, the existing maximum reflection light amount is equal to about 56% (70×(100−40/2)/100). Thus, if the reflection light amount of 14% (56×0.25) can be detected, a BCA of a new type can be detected even by a detecting method similar to that in the related art. In the case of a dual layer disc of a BD-ROM, it is sufficient that the reflection light amount of 6% can be detected.

Although the pit lengths have been compared by the continuous patterns of 2T and 8T for easy understanding in the description of the invention, the invention is not limited them. For example, if it is difficult to realize the groove structure, it is sufficient to assure the length of the pit portion and to shorten the length of the land portion as much as possible. For instance, even in a pattern like a combination of the 8T pit and the 2T land, the BCA modulation degree can be relatively easily assured.

### [Shape of Disc]

A shape of a read only disc which is used in the invention will be described. FIG. 8 illustrates a single layer ROM (read only) disc. FIG. 9 illustrates a dual layer ROM (read only) disc. A label surface on the side where a label is written and a recording surface on the side where a laser beam for reproduction enters exist on the single layer ROM disc illustrated in FIG. 8. From the recording surface side, the disc is constructed by a cover layer for protecting the recording surface, a recording layer in which the signal has been recorded, and a substrate layer under the recording layer. A label surface on which a label is written and a recording surface on the side where the laser beam for reproduction enters also exist on the dual layer ROM disc illustrated in FIG. 9. From the recording surface side, the disc is constructed by a cover layer for protecting the recording surface, a recording layer (L1) in which the signal has been recorded, a space layer for separating the recording layer (L1) from another recording layer, a recording layer (L0) in which another signal has been recorded, and a substrate layer under the recording layer (L0).

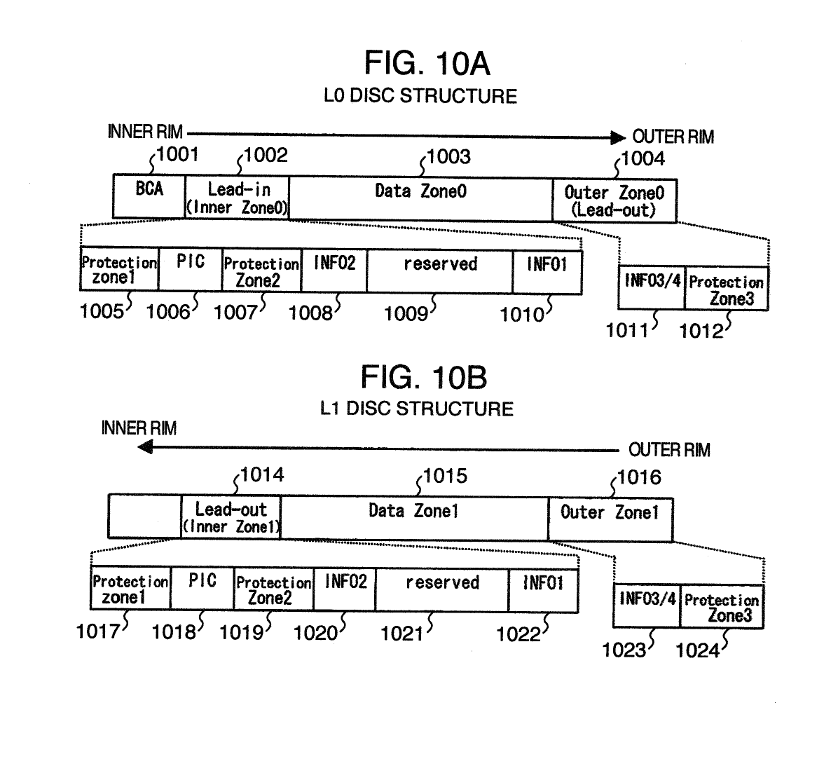

Subsequently, structures of the recording layers of the single layer ROM disc and the dual layer ROM disc are shown in FIGS. 10A and 10B. FIGS. 10A and 10B schematically illustrate the structures on the assumption that the left side of a disc cross section is set to an inner rim and the right side is set to an outer rim. FIG. 10A shows the disc structure of the recording layer L0 of each of the single layer ROM disc and the dual layer ROM disc. FIG. 10B shows the disc structure of the recording layer L1 of the dual layer ROM disc.

In the L0 disc structure of FIG. 10A, information peculiar to the disc and the like have been recorded in a BCA (1001). Attribute information regarding the disc, control information, and the like have been recorded in an Inner Zone 0 (1002). This area is also called “Lead-in”. User data such as AV data and the like have been recorded in a Data Zone 0 (1003). Control information and the like have been recorded in an Outer Zone 0 (1004). The Inner Zone 0 (1002) is constructed by a Protection Zone 1 (1005), a PIC (1006), a Protection Zone 2 (1007), an INFO 02 (1008), a reserved (1009), and an INFO 01 (1010). The Protection Zone 1 (1005) is an area for separating the BCA (1001) and PIC (1006). The following information and the like have been recorded in the PIC (1006): that is, information regarding a type of disc; information regarding a size of disc; information regarding a version of the disc; information regarding a structure of the disc; information regarding a channel bit length; information regarding the presence or absence of the BCA; information regarding a maximum transmission speed to be applied; and the like. The Protection Zone 2 (1007) is an area for separating the PIC (1006) and INFO 02 (1008). Control information has been recorded in the INFO 02 (1008). The reserved (1009) is a spare area. Control information has been recorded in the INFO 01 (1010). The Outer Zone 0 (1004) is constructed by an INFO 3/4 (1011) and a Protection Zone 3 (1012). Control information has been recorded in the INFO 3/4 (1011). The Protection Zone 3 (1012) is an area for further separating the INFO 3/4 (1011) and an outer rim portion. A long arrow directing from the inner rim of the L0 disc structure of FIG. 10A toward the outer rim indicates that in the recording area L0 of each of the single layer ROM disc and the dual layer ROM disc, data has been recorded so as to be read from the inner rim toward the outer rim.

In the L1 disc structure of FIG. 10B, attribute information regarding the disc, control information, and the like have been recorded in an Inner Zone 1 (1014). This area is also called “Lead-out”. User data such as AV data and the like have been recorded in a Data Zone 0 (1015). Control information and the like have been recorded in an Outer Zone 1 (1016). The Inner Zone 1 (1014) is constructed by a Protection Zone 1 (1017), a PIC (1018), a Protection Zone 2 (1019), an INFO 02 (1020), a reserved (1021), and an INFO 01 (1022). The Protection Zone 1 (1017) is an area for separating the inner rim side and the PIC (1018). The following information and the like have been recorded in the PIC (1018): that is, information regarding the type of disc; information regarding the size of disc; information regarding the version of the disc; information regarding the structure of the disc; information regarding the channel bit length; information regarding the presence or absence of the BCA; information regarding the maximum transmission speed to be applied; and the like. The Protection Zone 2 (1019) is an area for separating the PIC (1018) and INFO 02 (1020). Control information has been recorded in the INFO 02 (1020). The reserved (1021) is a spare area. Control information has been recorded in the INFO 01 (1022). The Outer Zone 1 (1016) is constructed by an INFO 3/4 (1023) and a Protection Zone 3 (1024). Control information has been recorded in the INFO 3/4 (1023). The Protection Zone 3 (1024) is an area for further separating the INFO 3/4 (1023) and the outer rim portion. A long arrow directing from the outer rim of the L1 disc structure of FIG. 10B toward the inner rim indicates that in the recording layer L1 of the dual layer ROM disc, data has been recorded so as to be read from the outer rim toward the inner rim

### [Encoding Process of Data]

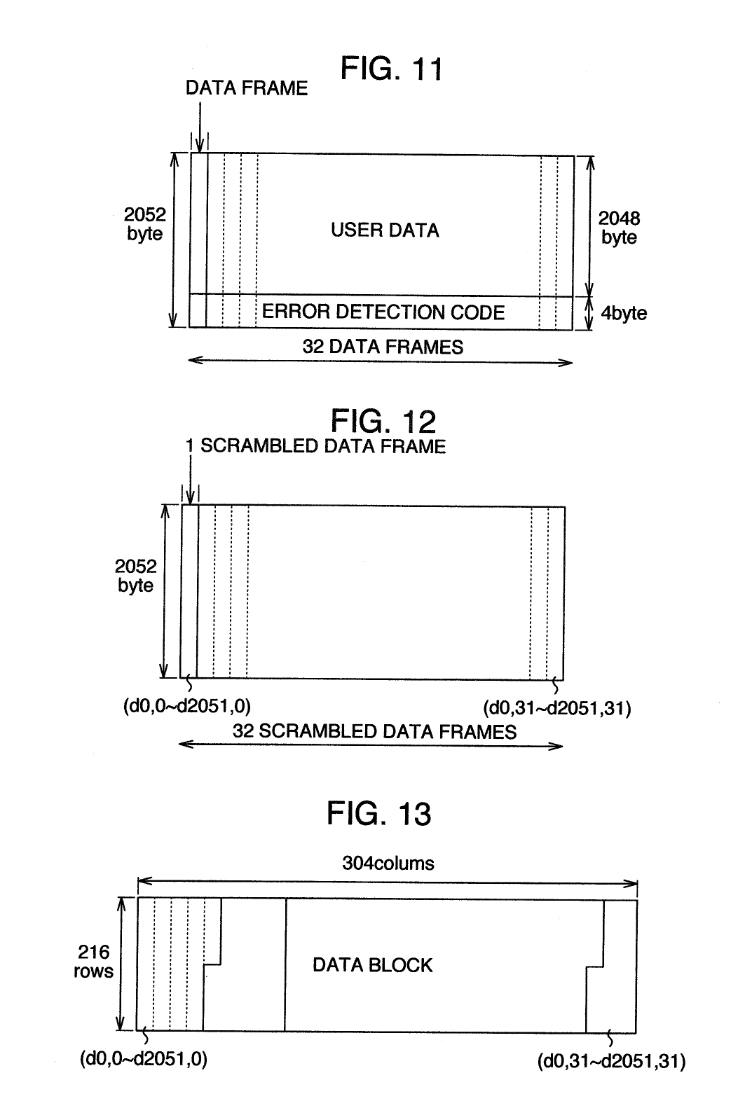

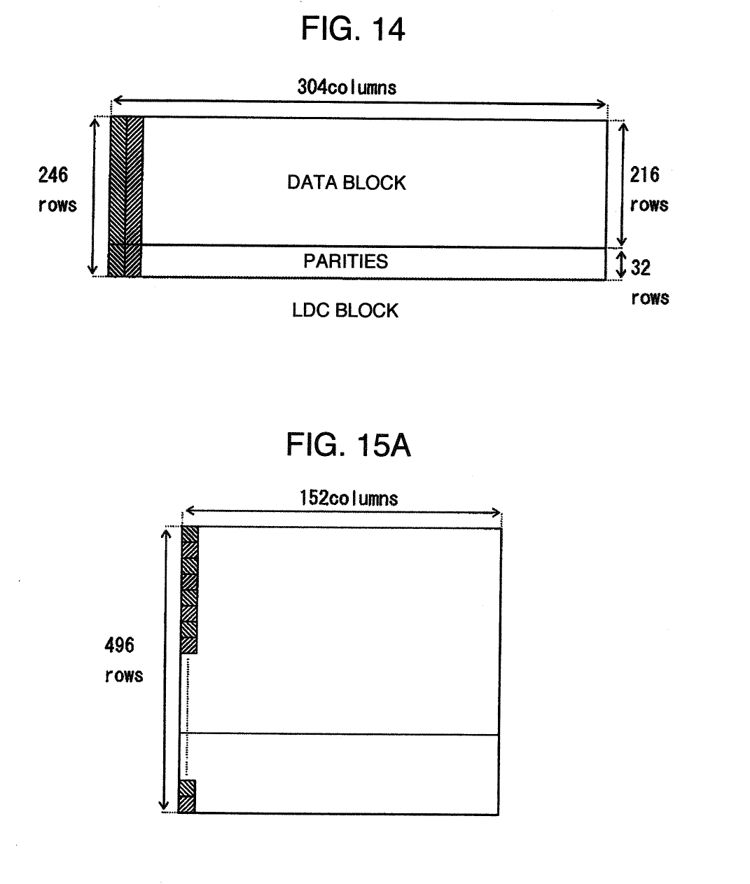

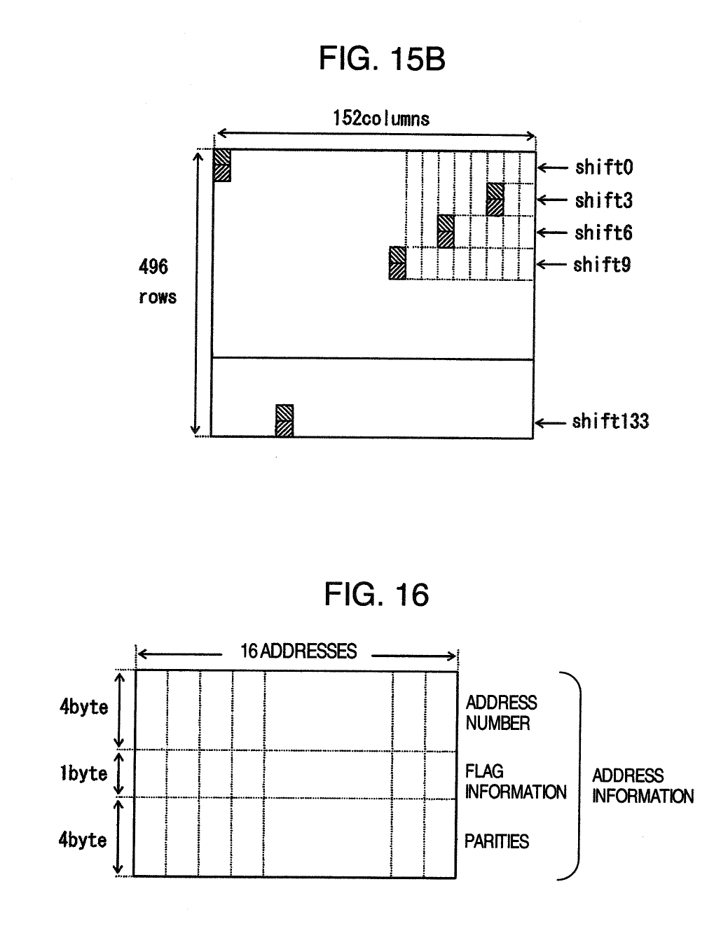

A recording process of the user data will now be described. As shown in FIG. 11, the user data is divided on a 2048-byte unit basis, an error detection code of 4 bytes is added to each divided data, and a data frame of 2052 bytes is constructed. Subsequently, as shown in FIG. 12, a scrambling process is executed to each data frame, thereby constructing a scrambled data frame. Then, as shown in FIG. 12, 32 scrambled data frames are collected. Subsequently, they are rearranged in order of columns and a data block of 216 rows and 304 columns is constructed as shown in FIG. 13. As shown in FIG. 14, an encoding is performed to each column of the data block by a Reed Solomon code of (248, 216, 32), parities of 32 bytes are added, and an LDC (Long Distance Code) block of 248 rows and 304 columns is newly constructed. The following first interleaving process and second interleaving process are executed to the LDC block. As shown in FIG. 15A, according to the first interleave, the rearrangement is performed so as to alternately sandwich the data of the even-number designated columns and the data of the odd-number designated columns subsequent thereto, thereby constructing a block of 496 rows and 152 columns. As shown in FIG. 15B, according to the second interleave, the rearrangement is performed to the rearranged block of 496 rows and 152 columns so as to increase a shift amount every 3 bytes on a 2-row unit basis from the top in such a manner that the first 2 rows are not shifted, the next 2 rows are shifted to the left by 3 bytes, the next 2 rows are shifted to the left by 6 bytes, and the next 2 rows are shifted to the left by 9 bytes. The data subjected to the first interleave and the second interleave constructs an LDC cluster.

Addresses which are added to the data block are formed as follows.

As shown in FIG. 16, the data block is divided into 16 address units and address information of 9 bytes is allocated to each address unit. The contents of 9 bytes are constructed by an address of 4 bytes, flag information of 1 byte, and parities of 4 bytes added to those address and flag information. An interleaving process is performed to this address and, thereafter, a matrix of 6 rows and 24 columns is formed. At the same time, user control data of 18 bytes and 32 units is arranged into a matrix of 24 rows and 24 columns.

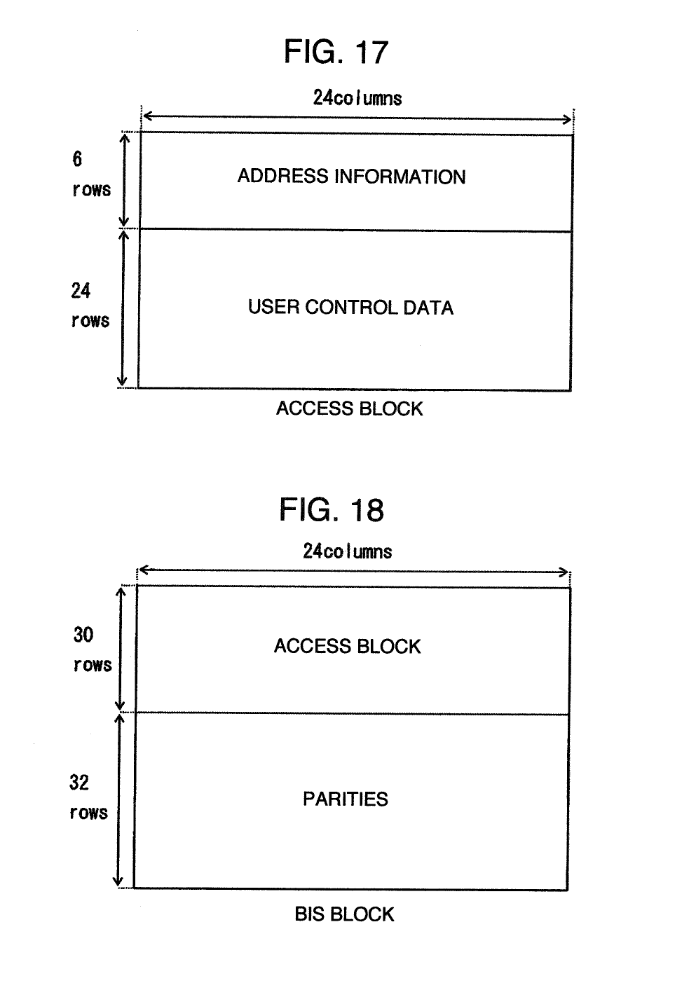

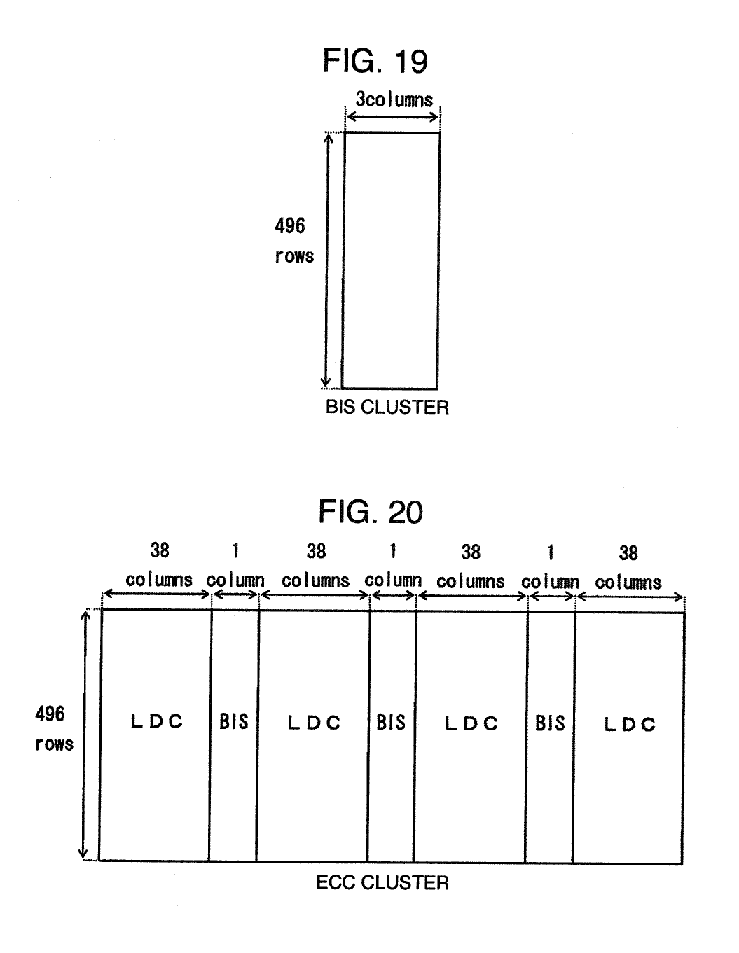

The matrix of 6 rows and 24 columns and the matrix of 24 rows and 24 columns are combined, so that an access block of 30 rows and 24 columns shown in FIG. 17 is formed. An encoding is performed to each column of the access block by a Reed Solomon code of (62, 33, 32), parities of 32 bytes are added, and a BIS (Burst Indicating Subcode) block of 62 rows and 24 columns shown in FIG. 18 is formed. The data of the BIS block is rearranged and a BIS cluster of 496 rows and 3 columns shown in FIG. 19 is constructed.

The LDC cluster is divided every 38 columns and the data of the BIS cluster is inserted between them every column, thereby constructing an ECC cluster shown in FIG. 20.

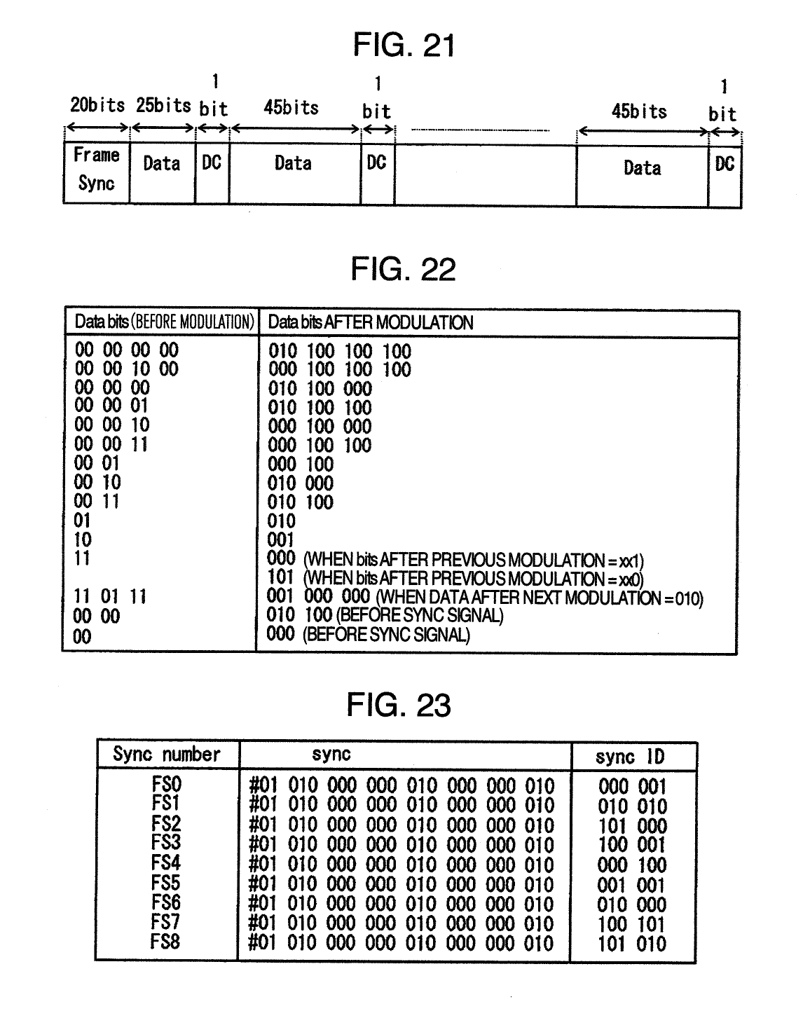

A frame sync signal of 20 bits is added to a head of the data of 155 bytes of each row of the ECC cluster. The data of 155 bytes is divided into head 25 bits and, subsequently, every 45 bits and a DC control bit is inserted between them, thereby constructing a recording frame shown in FIG. 21. The DC control bit is controlled so that the DSV after the modulation approaches 0.

The 1-7 modulation is performed to the data of the recording frame in accordance with a table shown in FIG. 22. The frame sync signal is added by using a sync code of 30 bits as shown in FIG. 23. In FIG. 23, if the data after the modulation before the sync code is terminated as 0000 or 00, # is equal to 1 and in other cases, # is equal to 0.

### [BCA]

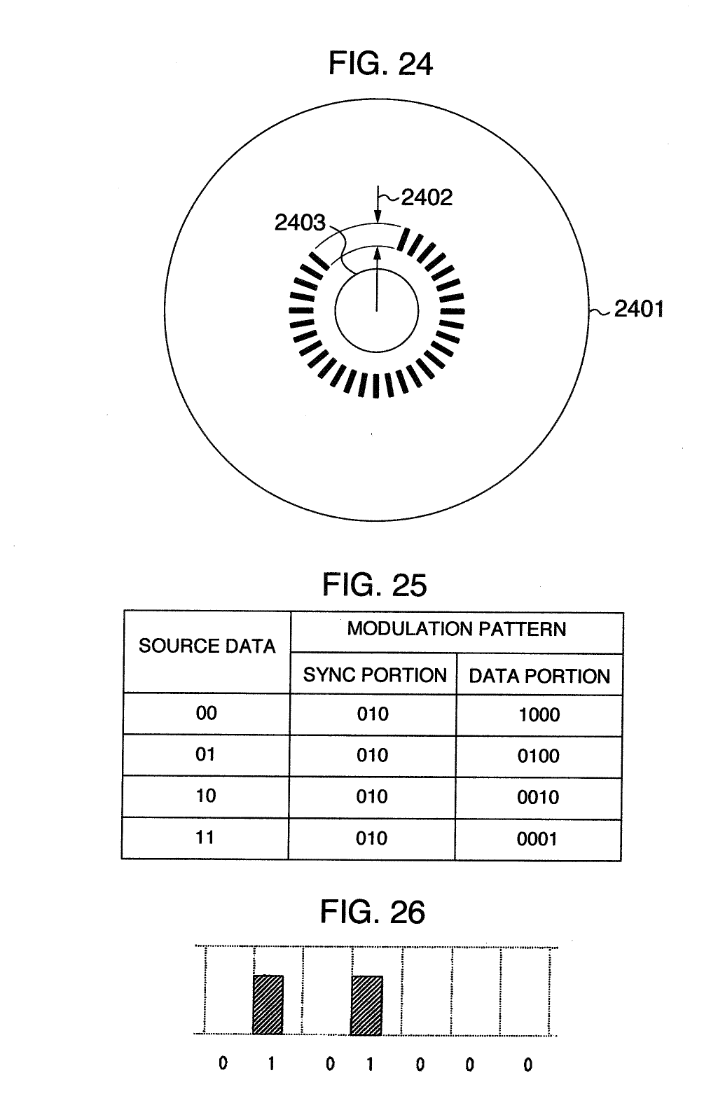

FIG. 24 shows a layout diagram when the layout of BCA shown in FIG. 10 is seen from an upper direction of an optical disc 2401. A burst cutting area (BCA) 2402 is concentrically formed in a range of a radius from 21.3 mm to 22.0 mm of the optical disc 2401. A center hole 2403 is shown. Information peculiar to the disc such as a disc ID or the like or format information which conforms with the disc or the like has been stored in the BCA. Such information occupies 4648 channel bits assuming that one circumference is constructed by about 4750 channel bits.

A modulating method of data which is recorded into the burst cutting area 2402 is shown in FIG. 25. According to the present modulating method, the data of 2 bits is modulated as 7-bit data. The 7-bit data after the modulation is constructed in such a manner that former half 3 bits are set to a sync portion and latter half 4 bits are set to a data portion. The sync portion is constructed only by “010”. In the data portion, “1” is set to one of 4 bits and “0” is set to the other bits. In FIG. 25, if original data is “00”, the data portion is modulated to “1000”. Similarly, original data “01”, “10”, and “11” are modulated to “0100”, “0010”, and “0001”, respectively.

A state where the sync portion and the data portion have been recorded in the burst cutting area 2402 is schematically shown in FIG. 26. In this case, data of “0101000” is shown. In the case of the bit “1”, a low-reflectance portion is formed. In the case of the bit “0”, a low-reflectance portion is not formed and a change in disc reflectance is equal to almost 0.

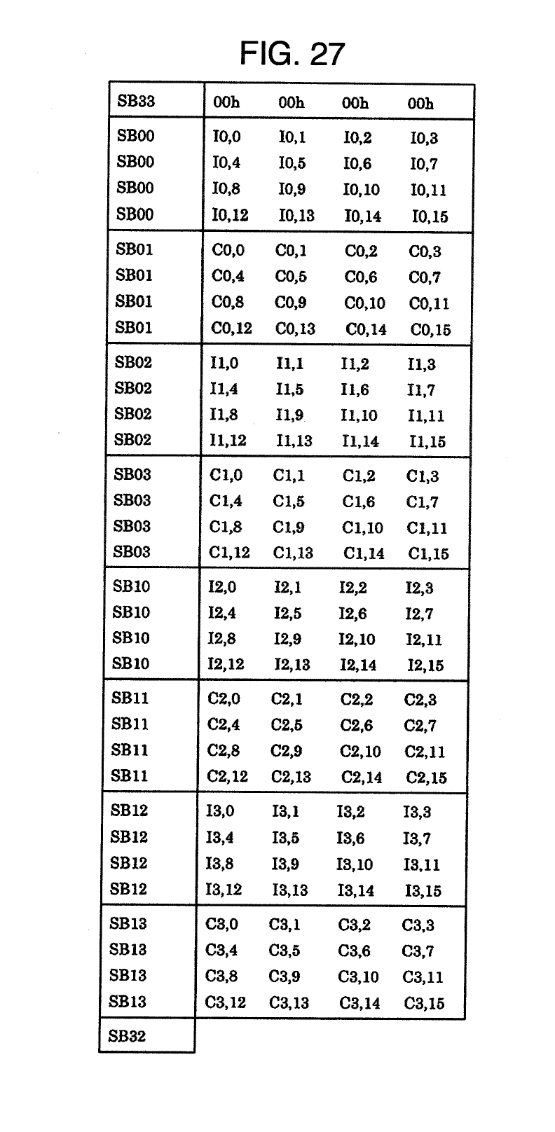

A structure of the data which is recorded in the burst cutting area 2402 is shown in FIG. 27. In FIG. 27, each row is constructed by 5 bytes. Head one byte of each row is a sync byte and subsequent four bytes are set to the data.

The first row is assumed to be a preamble and all bytes are set to 00h.

Since the first sync byte is used only in the first row, by detecting it, a start position of the BCA code can be detected or it can be also detected together with the 00h data after the first sync byte. As for the 2nd to 33rd rows, the areas are divided on a 4-rows unit basis. In the 2nd to 5th rows, the data of 16 bytes of user data I0,0 to I0,15 is arranged. Subsequently, in the 6th to 9th rows, parities C0,0 to C0,15 of 16 bytes corresponding to the user data I0,0 to I0,15 of the 2nd to 5th rows are arranged. One ECC block is constructed by the user data of the 2nd to 5th rows and the parities of the 6th to 9th rows.

Similarly, user data I1,0 to I1,15 is arranged in the 10th to 13th rows and parities C1,0 to C1,15 corresponding to the 14th to 17th rows are arranged. User data I2,0 to I2,15 is arranged in the 18th to 21st rows and parities C2,0 to C2,15 corresponding to the 22nd to 25th rows are arranged. User data I3,0 to I3,15 is arranged in the 26th to 29th rows and parities C3,0 to C3,15 corresponding to the 30th to 33rd rows are arranged.

Sync bytes of the 2nd to 5th rows are set to SB00. Sync bytes of the 6th to 9th rows are set to SB01. Sync bytes of the 10th to 13th rows are set to SB02. Sync bytes of the 14th to 17th rows are set to SB03. Sync bytes of the 18th to 21st rows are set to SB10. Sync bytes of the 22nd to 25th rows are set to SB11. Sync bytes of the 26th to 29th rows are set to SB12. Sync bytes of the 30th to 33rd rows are set to SB13. No data is arranged in the 34th row but only SB32 of the sync bytes is arranged. FIG. 27 shows the data before it is modulated in accordance with the modulating method of FIG. 25. An amount of such data is equal to 166 bytes (=5 bytes×4 rows×8 sets+5 bytes+1 byte). This information is modulated, so that it becomes 4648 channel bits (=166×8×7/2).

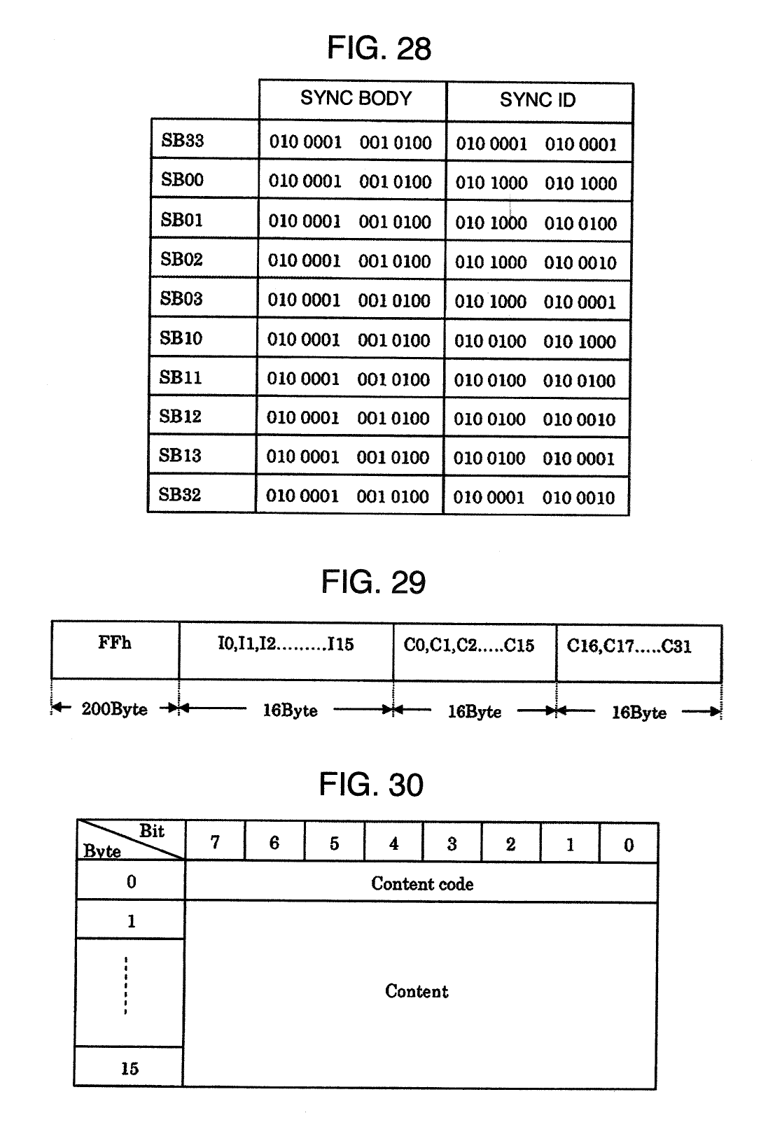

A specific data train of the sync signals in FIG. 27 is shown in FIG. 28. The example of FIG. 28 is expressed as a channel bit train. The sync byte of 28 channel bits is constructed by a sync body of 14 channel bits and a sync ID of 14 channel bits. The sync body of 14 channel bits is constructed by a sync body 1 of 7 channel bits and a sync body 2 of 7 channel bits. The sync ID of 14 channel bits is constructed by a sync ID 1 of 7 channel bits and a sync ID 2 of 7 channel bits.

The sync body has a pattern which does not conform with the inherent modulation rule mentioned above. That is, as shown in FIG. 25, if it conforms with the modulation rule, the sync portion ought to become “010”. However, the sync portion of the sync body 2 is set to “001” different from “010”. Therefore, the sync byte can be discriminated from the data.

The sync body 1 of each sync byte is set to “010 0001” and the sync body 2 is set to “001 0100”. On the other hand, the sync ID is set to a different value every sync byte, so that the sync byte can be discriminated. Since the sync bytes differ as mentioned above, they can be discriminated.

A construction of the ECC block of the BCA code is shown in FIG. 29. A Reed Solomon code of RS (248, 216, 33) is used as an ECC. It is a Reed Solomon code similar to that for the ECC block in FIG. 14. However, as shown in FIG. 29, in the ECC block of the BCA code, head 200 bytes are set to fixed data and, for example, FFh is used. Data of 16 bytes subsequent to the fixed data is set to the substantial user data of the BCA. Parities of 36 bytes are calculated by using the fixed data of 200 bytes and the BCA data of 16 bytes.

In the data of 216 bytes in the invention, head 200 bytes are set to fixed data and are not recorded to the optical disc. Similarly among the parities of 32 bytes, only parities C0 to C15 of head 16 bytes are recorded to the optical disc 2401 and parities of remaining 16 bytes are not recorded. Upon decoding, as for the fixed data of 200 bytes, the same value is used as it is. The parities of 16 bytes which are not recorded are decoded as an extinction flag. That is, among the parities of 32 bytes, the latter half 16 bytes are processed on the assumption that the located parities have been extinguished. Even if ½ of the parities were extinguished, since their positions have already been known, the original parities can be decoded.

By using the same RS (248, 216, 33) as that of the user data which is recorded in a user data area as mentioned above, even in the BCA, a very powerful error correcting ability can be realized. Since the circuit can be constructed by the same hardware, a circuit scale can be reduced and the costs can be reduced. Further, since it is sufficient to record only 32 bytes, as compared with the case of recording all of 248 bytes, a data capacity can be increased.

Subsequently, a construction of the data block of the BCA is shown in FIG. 30. In the invention, four ECC blocks are recorded into the burst cutting area 2402. The data of 16 bytes of each ECC block is constructed by a content code of head 1 byte and content data of subsequent 15 bytes. In the content code of the BCA, 6 bits in a range from head bit 7 to bit 2 are set to an application ID and 2 bits of last bit 1 and bit 0 are set to a sequence number.

The optical disc recording/reproducing apparatus can record or reproduce the data only to/from the optical disc having a predetermined application ID. For example, key information for encrypting/decrypting contents or the like which is necessary to protect the content data can be recorded to the disc having a specific application ID.

A sequence number is constructed by 2 bits and is set to one of “00”, “01”, “10”, and “11”. When content data of each ECC block is constructed by 14 bytes or less, each sequence number is set to “00”.

Subsequently, a storing method of the content data will be described. For example, if the same content data was stored as each content data of the head two ECC blocks among four ECC blocks (in this case, the same content data of the same application ID is written twice), a sequence number of each ECC block is set to “00”. That is, in the case of recording the same content data, the sequence numbers of the two ECC blocks are set to the same number.

Subsequently, 24 bytes of the content data different from the application ID of the first ECC block are stored into the remaining two ECC blocks, the sequence number of the first ECC block is set to “00” and the sequence number of the second ECC block is set to “01”. That is, if the content data is stored into a plurality of ECC blocks, the sequential numbers are stored.

Since the application ID and the sequence number are recorded into each ECC block as mentioned above, whether desired data has been stored in which one of the ECC blocks or it has been multiple-recorded can be discriminated by checking them.

A BCA content code of the data block and content data in FIG. 30 correspond to I0,0 to I0,15 of the head ECC block in FIG. 27.

### [Recording/Reproducing Apparatus of Disc]

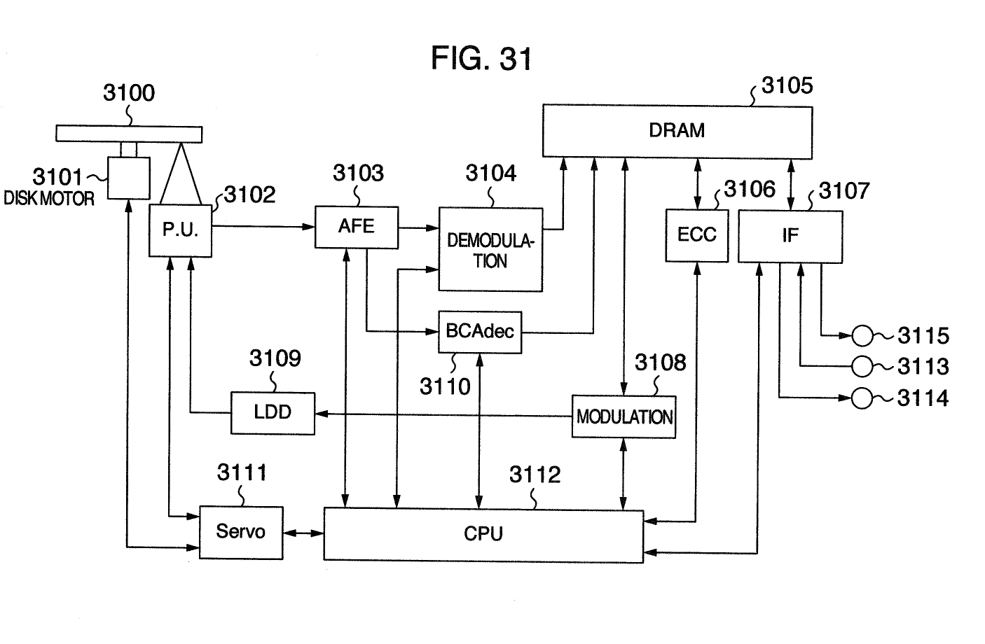

A recording/reproducing apparatus for reproducing the optical disc which has been described with respect to the shape, the encoding process of the data, and the BCA as a preferred example in the invention will now be explained with reference to FIG. 31. FIG. 31 is a block diagram of the recording/reproducing apparatus. In FIG. 31, reference numeral 3100 denotes a read only disc shown in FIGS. 8, 9, 10A, and 10B or a recordable disc generally having a common shape. Reference numeral 3101 denotes a disc motor for rotating the disc 3100. An optical pickup 3102 irradiates a laser beam to the disc 3100, detects reflection light, and obtains a reproduction signal. Upon recording, the optical pickup 3102 irradiates the laser beam of a waveform which has accurately been shaped to the disc 3100, thereby performing the recording. An analog front end 3103 executes a waveform shaping of the signal detected by the optical pickup 3102, a generation of a servo signal, and the like. A demodulation processing circuit 3104 executes a binarization of the waveform-shaped signal, a demodulating process based on the 1-7 modulation described in the encoding process of the data, and the like. A DRAM (Dynamic Random Access Memory) 3105 is used to temporarily store demodulated data, data during a correcting process, input/output data, data before the modulating process, and the like. At the time of a reproducing process, an ECC (Error Correction Code) 3106 executes an error correcting process to the demodulated data which has temporarily been stored in the DRAM 3105. At the time of a recording process, the ECC 3106 adds an error correction code to the input data which has temporarily been stored in the DRAM 3105. An interface circuit 3107 executes such an interface process that the data which has temporarily been stored in the DRAM 3105 is output from an output terminal 3114, input data from an input terminal 3113 is stored in the DRAM 3105, BCA related information stored in the DRAM 3105 is output from an output terminal 3115, and the like. The input terminal 3113 and output terminal 3115 can be also constructed as a common terminal. The input terminal 3113, output terminal 3114, and output terminal 3115 can be also constructed as a common terminal by bidirectionally transmitting data. A modulating circuit 3108 executes a modulating process based on the 1-7 modulation described in the encoding process of the data to the data read out of the DRAM 3105 and supplies modulation data to an LDD (Laser Diode Driver) 3109. Upon recording, the LDD 3109 supplies a recording waveform suitable for recording of the modulation data to the optical pickup 3102. The optical pickup 3102 emits light in accordance with the recording waveform, thereby performing the recording. Upon reproduction, a BCA decoder 3110 executes a decoding process of the data block of the BCA recorded in accordance with the presence or absence of the low reflectance as described in [BCA]. A servo 3111 is coupled to and configured to control the disk motor 3101 and the optical pickup 3102. A CPU 3112 is coupled to and configured to control some of above-described electrical components.

It should be further understood by those skilled in the art that although the foregoing description has been made on embodiments of the invention, the invention is not limited thereto and various changes and modifications may be made without departing from the spirit of the invention and the scope of the appended claims.

1. An optical information medium corresponding to a BCA of an optical disc, wherein in the BCA, an area serving as a level on a high-reflection side of a signal which is binary-detected from a change in reflectance is set to a level of an almost constant reflection light amount without a modulation and an area serving as a level on a low-reflection side is formed by pits modulated by a modulating method similar to a data modulating method for performing recording/reproduction, and a detection level at the time of performing the binary detection can be subjected to a slice for the binary detection by a level at which maximum reflectance that is presumed in the case where the area is constructed by the pits which were data-modulated to the low-reflection side of the binary signal is lower than 56%.

2. A medium according to claim 1, wherein in the BCA of the optical disc, in the case of a single layer blu-ray disc, the binary detection level of the BCA is equal to or less than the reflectance of 14%.

3. The medium according to claim 1, wherein in the BCA of the optical disc, in the case of a dual layer blu-ray disc, the binary detection level of the BCA is equal to or less than the reflectance of 6%.

4. The medium according to claim 1, wherein in the BCA of the optical disc, the area of the low-reflection side at the time of performing the binary detection has a pit structure of a depth of almost ¼ of a wavelength of light for performing the recording/reproduction.

5. An optical information medium corresponding to a BCA of an optical disc, wherein an area serving as a level on a high-reflection side of a signal which is binary-detected from a change in reflectance is set to a level of an almost constant reflection light amount without a data modulation and an area serving as a level on a low-reflection side is constructed by a groove portion of low reflectance and a mirror portion of high reflectance, and a detection level at the time of performing the binary detection can be subjected to a slice for the binary detection by a reflection level of almost ¼ of maximum reflectance that is presumed in the case where the area is constructed by the data-modulated pits to the low-reflection side of the binary signal.

6. The medium according to claim 5, wherein the groove portion of the low reflectance on the low-reflection side of the signal which is binary-detected is set to the level of the almost constant reflection light amount without the modulation.

7. The medium according to claim 5, wherein the groove portion of the low reflectance on the low-reflection side of the signal which is binary-detected is constructed by a combination of a longest pit length and a shortest land length in a modulating method of the optical information medium.

8. The medium according to claim 5, wherein the groove portion of the low reflectance on the low-reflection side of the signal which is binary-detected is constructed by a combination of a pit length which is equal to or larger than a longest pit length and a shortest land length in a modulating method of the optical information medium.

9. The medium according to claim 5, wherein the groove portion of the low reflectance on the low-reflection side of the signal which is binary-detected is constructed by a pit length and a land length of almost the half of a standard light spot width of the optical information medium.

10. The medium according to claim 1, wherein in the BCA structure, a pit width of the pit which is formed in the area serving as a level on the low-reflection side of the signal which is binary-detected from the reflectance change is almost the half of a spot size for performing the recording/reproduction.

11. The medium according to claim 5, wherein in the BCA structure, a pit width of the pit which is formed in the area serving as a level on the low-reflection side of the signal which is binary-detected from the reflectance change is almost the half of a spot size for performing the recording/reproduction.
